(19) United States
(12) Patent Application Publication
(10) Pub. No.: US 2006/0265380 A1
(43) Pub. Date: Nov. 23, 2006

(54) METHODS, SYSTEMS, AND COMPUTER PROGRAM PRODUCTS FOR PREVENTING DOUBLE FORM SUBMISSION AT A USER AGENT

(76) Inventors: Jared Fry, Boston, MA (US); Robert Paul Morris, Raleigh, NC (US)

Correspondence Address: SCENERA RESEARCH, LLC, 111 CORNING RD., SUITE 220, CARY, NC, 27511, US

(21) Appl. No.: 10/908,693

(22) Filed: May 23, 2005

(51) Int. Cl. G06F 17/30; G06F 7/00

(52) U.S. Cl. 707/10

(57) ABSTRACT

Methods, systems, and computer program products are disclosed for preventing double form submissions at a user agent in a communication network. A form is received from a remote endpoint in the communication network. User input is monitored to detect submission initiation for the received form. In response to detecting submission initiation for the received form, the user agent determines whether a matching previous form submission exists. The determination of whether a matching previous form submission exists is performed by the user agent independent of any scripts received with the form. Submission of the received form is controlled based on the determination of whether a matching previous form submission exists.

### TECHNICAL FIELD

The subject matter described herein relates to data processing and storage at a user agent. More particularly, the subject matter described herein relates to preventing double submission of forms submitted at a user agent via a communication network.

### BACKGROUND

Generally speaking, forms are documents with blank fields for the addition of details or information. Forms offer the advantages of providing the ability to gather specific information easily and uniformly without having to recreate an entire document. While forms have historically been paper-based, forms are increasingly being used in electronic format in a variety of ways. For example, electronic forms are often used with computers to allow users to conveniently enter input data into specific fields by typing on a keyboard. Electronic forms are commonly used between computers and other electronic devices for gathering, exchanging, and recording information in a uniform, easily recognizable format. Electronic forms are commonly used, for example, in e-commerce in connection with the buying, selling, marketing, and servicing of products or services over computer networks, as well as for a variety of other purposes, such as inventory control, employment applications, joining mailing lists, making suggestions, requesting information, and many others.

A software application operating on a user (or client) electronic device, such as a computer, personal digital assistant (PDA), mobile telephone, and the like, can provide users with the ability to add information to a form and to submit the form to another entity using some means of data transmission. Such client-based software applications are referred to herein (singular or plural) as a “user agent”. One example of a user agent is a web browser.

Usually, for a user to submit form data, they must press a particular button, e.g., a ‘submit’ button, (or press the enter key when that button is in focus) that is coded to perform initiate a submit operation, which instructs the user agent to send the form data to a server for processing. Upon receiving the form data, the server will begin processing the data and may send a response to the user indicating to the user (either directly or indirectly) that the information was received by the server and is being processed.

Processing of the form data may be delayed as a result of a number of factors, such as slow or overloaded servers, slow clients, network congestion, and or slow communication channels. As a result, a user that presses the submit button or otherwise initiates a submit operation will not always see an immediate response from the processing server. The user agent typically leaves the web page from which the form was submitted displayed until the user agent receives a response from the server indicating that the form data has been processed. For example, the server may send a confirmation web page to the user agent for display. During this processing/confirmation period, the page that contained the submitted form is still presented to the user and appears to be active to the user. Consequently, the user has the capability to re-submit the form data by, for example, pressing the submit button again before the server has had time to respond to the first submission.

In today's fast-paced society, it is not uncommon for users to become impatient and re-submit their form data in an ill-advised attempt to make the server react faster. Other circumstances exist in which a user may inadvertently cause a double submission of a form. For example, a user may begin to question if they had pushed the submit button and resort to pushing it again. A user may push a stop button while waiting for a response and then hit the submit button again. Moreover, there are circumstances where even after receiving a confirmation that the form data was processed a user may inadvertently resubmit the form data again. For example, in some cases, a user hitting the ‘reload’ button (also referred to as the ‘refresh’ button) may cause the form data to be submitted again.

Double submission of form data often causes undesired results, especially in e-commerce transactions. There have been instances of purchasing plane tickets twice, purchasing products twice, or sending web-based emails twice.

Many servers are able to determine when form data was submitted twice by the user and have the intelligence to filter out redundant submissions. Additionally, web pages can be altered to prevent submission of form data twice. For example, U.S. Pat. No. 6,237,035 describes a method for controlling duplicate transaction submissions by either tracking submissions at the server and by tracking submissions using scripts added to the form at the server-side. Both of these solutions, however, require specific application code dedicated to preventing double submissions to be included in the server-side software and/or the served web pages to implement them. Consequently, the user is at the mercy of server-side-dependent implementations, such as server-side applications and web page authoring. That is, a user agent has no assurances that double submission will be prevented for any given web page submitted to any given server.

Accordingly, in light of these difficulties associated with electronic form submissions, there exists a need for methods, systems, and computer program products for preventing double form submission at a user agent.

### SUMMARY

In one aspect of the subject matter disclosed herein, a method is disclosed for preventing double form submissions at a user agent in a communication network. A form is received from a remote endpoint in the communication network. User input is monitored to detect submission initiation for the received form. In response to detecting submission initiation for the received form, the user agent determines whether a matching previous form submission exists. The determination of whether a matching previous form submission exists is performed by the user agent independent of any scripts received with the form. Submission of the received form is controlled based on the determination of whether a matching previous form submission exists.

In another aspect of the subject matter disclosed herein, a computer program product that includes computer executable instructions embodied in a computer-readable medium is disclosed. At a user agent in a communication network, a form is received from a remote endpoint in the communication network. User input is monitored to detect submission initiation for the received form. In response to detecting submission initiation for the received form, the user agent determines whether a matching previous form submission exists. The determination of whether a matching previous form submission exists is performed by the user agent independent of any scripts received with the form. Submission of the received form is controlled based on the determination of whether a matching previous form submission exists

In another aspect of the subject matter disclosed, a system is disclosed for preventing double form submissions. The system includes means for interfacing a user agent to a communication network for receiving a form from a remote endpoint in the communication network and for submitting forms, means for detecting a form submission, means for determining whether a matching previous form submission exists independent of any scripts received with the form, and means for controlling submission of the received form based on the determination of whether a matching previous form submission exists.

In another aspect of the subject matter disclosed, a system is disclosed for preventing double form submissions. The system includes a network interface that interfaces a user agent to a communication network for receiving a form from a remote endpoint in the communication network and for submitting forms, an activity monitor that detects a form submission, and a control manager that determines whether a matching previous form submission exists independent of any scripts received with the form and controls submission of the received form based on the determination of whether a matching previous form submission exists.

### BRIEF DESCRIPTION OF THE DRAWINGS

Objects and advantages of the present invention will become apparent to those skilled in the art upon reading this description in conjunction with the accompanying drawings, in which like reference numerals have been used to designate like elements, and in which:

FIG. 1 is a block diagram illustrating a typical communication arrangement for form submissions;

FIG. 2 is a signaling diagram illustrating an exemplary signaling scenario for a form submission;

FIG. 3 is a schematic diagram illustrating an exemplary form;

FIG. 4 is a block diagram illustrating a system for preventing double form submissions according to an aspect of the subject matter disclosed herein;

FIG. 5 is a schematic diagram illustrating an exemplary log that may be used for submitted form identifying information in memory according to another aspect of the subject matter described herein;

FIG. 6 is a flow diagram illustrating a method for preventing double form submissions at a user agent in a communication network according to an aspect of the subject matter disclosed herein; and

FIG. 7 is a flow diagram illustrating a method for preventing double form submissions at a user agent in a communication network according to another aspect of the subject matter disclosed herein.

### DETAILED DESCRIPTION

To facilitate an understanding of exemplary embodiments, many aspects are described in terms of sequences of actions that can be performed by elements of a computer system. For example, it will be recognized that in each of the embodiments, the various actions can be performed by specialized circuits or circuitry (e.g., discrete logic gates interconnected to perform a specialized function), by program instructions being executed by one or more processors, or by a combination of both.

Moreover, the sequences of actions can be embodied in any computer-readable medium for use by or in connection with an instruction execution system, apparatus, or device, such as a computer-based system, processor containing system, or other system that can fetch the instructions from a computer-readable medium and execute the instructions.

As used herein, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

Thus, the subject matter described herein can be embodied in many different forms, and all such forms are contemplated to be within the scope of what is claimed.

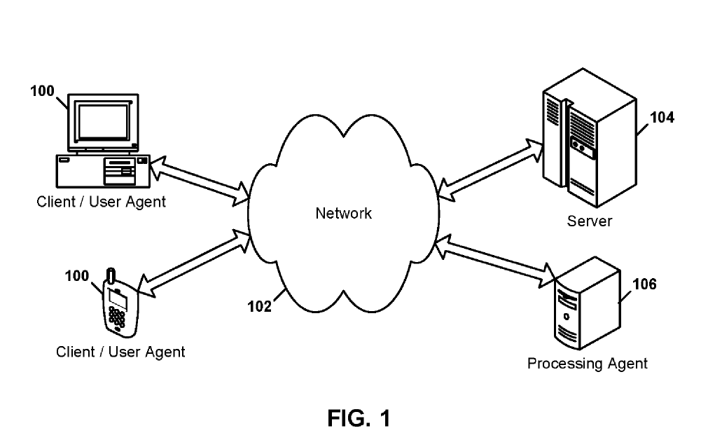

FIG. 1 is a block diagram illustrating a typical communication arrangement for form submissions. In FIG. 1, a client 100 communicates via a network 102 with a server 104 and a processing agent 106. Client 100 may be, for example, a computer. Alternatively, client 100 may be any suitable communication device, such as a mobile phone, a personal digital assistant, a terminal, or the like. More particularly, client 100 may be any processor-based system capable of communicating via a communication network to receive and submit forms. Client 100 also includes a user agent application with instructions for client 100 to interpret received forms, to submit forms, and to interpret confirmation pages. User agent applications suitable for use with embodiments of the subject matter disclosed herein include visual browsers (both text-only and graphical) and non-visual browsers (e.g., audio, Braille). An example of a visual browser is a web browser, such as MOZILLA FIREFOX™. Network 102 may be any communication network, including any packet-based network, (e.g., the Internet, wide area network, and/or local area network), a telecommunications network (e.g., public switched telephone network), a radio communication network, and the like, or any combination thereof.

Server 104 and processing agent 106 may be applications running on processor-based systems. Server 104 is adapted to provide one or more forms to client 100 that are tailored to request specific information from client 100. Typically, the requested information is provided by a user with access to client 100. Examples of specific information that may be requested by server 104 include a user's name, address, e-mail address, phone number, credit card information, and other items selected for purchase from an e-commerce site. Processing agent 106 is adapted to receive and process the specific information provided by client 100 in response to the form being submitted. Processing agent 106 will typically employ security mechanisms, such as secure connections with client 100 through network 102, data encryption, and other security measures, since it processes sensitive user information. Although server 104 and processing agent 106 are logically shown separately, it will be understood that they may be the same application and/or processor-based system.

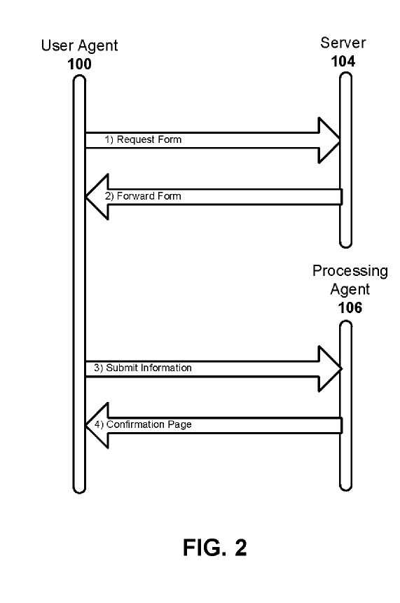

FIG. 2 is a signaling diagram illustrating an exemplary signaling scenario for a form submission. In FIG. 2, user agent 100 requests a form from server 104. For example, a user at user agent 100 may be viewing a web page on a website and decide to purchase an item or submit information for other purposes. The user initiates a request for a web page containing a form. server 104 forwards the form. The user supplies the information requested by the form and initiates a form submission, for example by pressing a submit button associated with the form. The request may be, for example, an hypertext transfer protocol (HTTP) request using the GET method (discussed further below). The user-supplied information is forwarded to a processing agent 106, where the submitted information is processed and a confirmation page is returned. For example, processing agent 106 may send an HTTP response.

Conventional solutions for preventing double submission of forms, such as the solution disclosed in U.S. Pat. No. 6,237,035, have required the use of an application at server 104 and/or processing agent 106 and/or adding scripts to the form at the server-side for filtering out double form submissions. Both of these approaches, however, place the user at the mercy of server-side-dependent implementations and provide no assurances that double submission will be prevented for any given web page submitted to any given server. The subject matter disclosed herein provides methods, systems, and computer program products that prevent double submission of forms at a user agent independent of scripts on a form. Moreover, the prevention of double submission is performed by the user agent, not by server 104 or processing agent 106. Consequently, the subject matter disclosed herein allows a user to control double submission of forms at client 100, even when server 104, processing agent 106, and/or the form is devoid of any special programming or functionality and/or scripts to detect and control such double form submissions, which offers significant advantages over conventional approaches. Nevertheless, it is contemplated that the techniques described here can be combined with the conventional solutions discussed above without departing from the scope of the claimed subject matter.

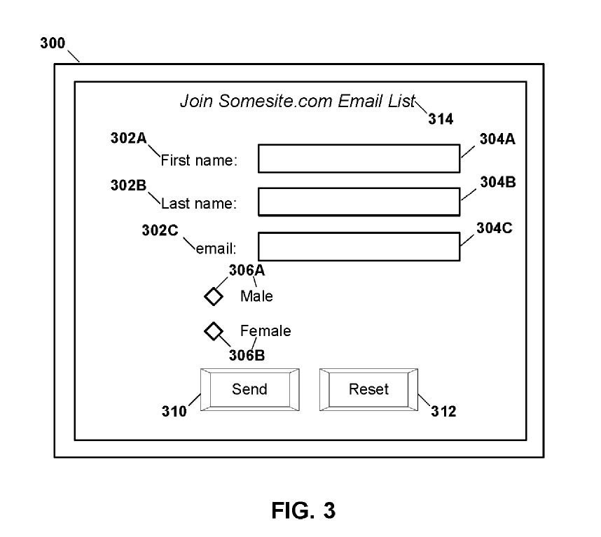

FIG. 3 is a schematic diagram illustrating an exemplary form 300. In FIG. 3, form 300 includes labels 302A-C, corresponding controls 304A-C, radio buttons 306A-B with corresponding labels, a send button 310, a reset button 312, and additional text content 314. Form 300 may be presented on a display in a processor-based system, such as client 100, under the control of a user agent or another application. For example, form 300 may be a web form, i.e., a form included on a web page accessed via the World Wide Web. That is, form 300 may be a web form downloaded by a user agent, such as a web browser, from a website on the Internet from a remote endpoint, such as server 104. Alternatively, form 300 may be any form available for download and processing by a user agent via a communication network. Other examples include a company local area network, or wide area network that has remote form storage on a server or other form storage device.

For the present purposes, an exemplary implementation of methods, systems, and computer program products for preventing double form submissions will be described herein with reference to form submissions via the World Wide Web using a hypertext markup language (HTML) compatible user agent, such as current web browsers available for personal computing. An example of an HTML compatible user agent is MOZILLA FIREFOX™. It should be understood, however, that the subject matter described herein is not intended to be limited to HTML, the World Wide Web, the Internet, web browsers, or other implementation-specific infrastructure or functionality described herein. Instead, the concepts described herein may be applied by one of ordinary skill in this art to other applications and infrastructures suitable for carrying out form submissions.

HTML is a standard generalized markup language (SGML) application conforming to International Standard ISO 8879 used as the publishing language of the World Wide Web (Web). The current HTML specification version is HTML 4.01, Dec. 24, 1999, and was prepared as a recommendation by The World Wide Web Consortium (W3C). HTML 4.01 is incorporated by reference herein in its entirety. The Web is a network of information resources that employs uniform mechanisms to make the resources readily available to the widest possible audience. These mechanisms include the use of a uniform naming scheme for locating resources on the web, i.e., uniform resource indicators (URI's), specific protocols for access to named resources over the Web, such as HTTP, and hypertext languages, such as HTML, for easy navigation among resources. An HTML document is divided into a head section, typically bounded between <HEAD> elements, and a body section, typically bounded between <BODY> elements. The title of the document appears in the head (along with other information about the document), and the content of the document appears in the body.

HTML provides a universally understood language to publish information for global distribution via the Web. For example, HTML is used to publish online documents with headings, text, tables, lists, photos, etc., to retrieve online information via hypertext links, and to design forms for conducting transactions with remote services (e.g., making reservations, ordering products, etc). HTML supports the inclusion of spread-sheets, video clips, sound clips, and other applications directly in documents.

HTML documents from a common source, e.g., part of the same web site, will typically have similar patterns in the content associated with each page. For example, the body section will have similar content from one page to the next, such as a title, company name, logo, etc. A user agent can be configured to detect such a similarity in content patterns, as discussed further below.

Every resource available on the Web, such as an HTML document, image, video clip, program, etc., has an address that may be encoded by a URI. A URI typically consists of a naming scheme of the mechanism used to access the resource, a name of the machine hosting the resource, and a name of the resource itself, given as a path. For example, the URI that designates the W3C Technical Reports page is “http://www.w3.org/TR”, which designates that there is a document available via the HTTP protocol, residing on the machine “www.w3.org”, accessible via the path “/TR”. This type of URI, which defines a route to a web page and uses HTTP protocol, is often referred to as a uniform resource locator (URL). Other URI designations in HTML documents include “mailto” for e-mail and “ftp” for file transfer protocol (FTP). An example of a mailto URI is <A href=“mailto:joe@someplace.com”>Joe </A>.

In HTML, URI's are used to link to another document or resource (using the A and LINK elements), link to an external style sheet or script (using the LINK and SCRIPT elements, include an image, object, or applet in a page, (using the IMG, OBJECT, APPLET and INPUT elements), create an image map (using the MAP and AREA elements), submit a form (using the GET or POST method attribute), create a frame document (using the FRAME and IFRAME elements), cite an external reference (using the Q, BLOCKQUOTE, INS and DEL elements), and refer to metadata conventions describing a document (using the HEAD element).

HTML documents from a common source, e.g., part of the same web site, will typically have similar patterns in the URI's associated with each page. For example, two pages from the same website having a URI “http://www.w3.org” may have URI's “http://www.w3.org/TR” and “http://www.w3.org/ST”. In such a case, the pattern “http://www.w3.org” is common to both URI's. Additionally, documents from a common source will typically have hyperlinks with URI's pointing to each other. In each case, a user agent can be configured to detect such a similarity in URI patterns, as discussed further below.

Returning to FIG. 3, HTML can be used to design forms for downloading by a user agent for use by a user. An HTML form (also referred to as a web form) is a section of an HTML document that contains normal content, markup, special elements called controls (including checkboxes, radio buttons, menus, and others), and labels on those controls. Users generally “complete” a form by modifying its controls (entering text, selecting menu items, etc.), before submitting the form to an agent for processing (e.g., to a web server, to a mail server, etc.). HTML code for form 300 is shown below with line numbers in brackets corresponding to the reference numerals of FIG. 3 added to the right of respective lines of HTML.

<FORM action=“http://somesite.com/prog/adduser”
method=“post”>

| <P> | |
|---|---|
| <LABEL for=“firstname”>First name: </LABEL> | [302A] |

| | |
|---|---|
| <INPUT type=“text” id=“firstname”><BR> | [304A] |

| | |
|---|---|
| <LABEL for=“lastname”>Last name: </LABEL> | [302B] |

| | |
|---|---|
| <INPUT type=“text” id=“lastname”><BR> | [304B] |

| | |
|---|---|
| <LABEL for=“e-mail”>e-mail: </LABEL> | [302C] |

| | |
|---|---|
| <INPUT type=“text” id=“e-mail”><BR> | [304C] |

| | |
|---|---|
| <INPUT type=“radio” name=“sex” value=“Male”> | [306A] |
| Male<BR> | |
| <INPUT type=“radio” name=“sex” value=“Female”> | [306B] |
| Female<BR> | |

| | |
|---|---|
| <INPUT type=“submit” value=“Send”> <INPUT | [310/312] |
| type=“reset”> | |
| </P> | |

</FORM>

Users and user agents interact with forms through the controls, such as text input 304A-C, radio buttons 306A and 306B, buttons 310 and 312, and others not shown in FIG. 3, including checkboxes, menus, file select, hidden controls, and object controls. A control's “control name” is given by its name attribute. Each control 304 has both an “initial value” and a “current value”, both of which are character strings. In general, a control's initial value may be specified with the control element's value attribute, and can be blank or null. The control's current value is first set to the initial value. Thereafter, the control's current value may be modified through user interaction and scripts. For example, a user may type his or her first name into text input control 304A using a keyboard. The current value then becomes the typed-in user's first name. Alternatively, a user agent may employ an auto-fill feature that has previously stored information and recognizes a control on a form, determines the information requested according to its name attribute, and automatically fills in a user's first name using the previously stored information.

Reset button 312 is used to reset all controls on form 300 to their respective initial values when clicked by a user. Submit button 310 (labeled “send”) is used to submit a form to a processing agent when clicked by a user. When a form is submitted for processing, controls are paired (by their control names) with their current value and these pairs are submitted. Those controls for which name/value pairs are submitted are called successful controls.

Radio buttons 306A and 306B operate similarly to the well known checkboxes, except that when several share the same control name, they are mutually exclusive: when one is switched “on”, all others with the same name are switched “off”. The INPUT element is used to create a radio button control. Checkboxes (not shown), in contrast, are on/off switches that may be toggled by the user independently of other check boxes. A switch is “on” when the control element's checked attribute is set. The INPUT element is also used to create a checkbox control.

Another control not shown in FIG. 3 is a push button, which is a button with no default behavior (i.e., a button other than the submit and reset buttons). Each push button may have scripts associated with the element's event attributes. When an event occurs (e.g., the user presses the button, releases it, etc.), the associated script is triggered. Buttons are created with the BUTTON element or the INPUT element. A menu control is a control that offers users options from which to choose. The SELECT element creates a menu, in combination with the OPTGROUP and OPTION elements. Text input controls 304A-C allow users to input a single-line input control. A TEXTAREA element is used to create a multi-line input control. File select controls allow users to select files so that their contents may be submitted with a form. The INPUT element is also used to create a file select control. Hidden controls are controls that are not rendered but whose values are submitted with a form. This control type is generally used to store information between client/server exchanges that would otherwise be lost due to the stateless nature of HTTP. The INPUT element is also used to create a hidden control. Object controls are used to insert generic objects in forms such that associated values are submitted along with other controls. Object controls are created with the OBJECT element.

When a user agent submits form data to a processing agents (e.g., responsive to a user clicking the submit button), the method attribute of the FORM element specifies the HTTP method used to send the form to the processing agent. The method attribute may be a GET method or a POST method. The HTTP GET method appends the form dataset to the URI specified by the action attribute (with a question-mark “?” as separator), and this new URI is sent to the processing agent. The HTTP POST method instead includes the form data set in the body of the form and sends it to the processing agent. A successful control is one that is “valid” for submission. Every successful control has its control name paired with its current value as part of the submitted form data set. If a control doesn't have a current value when the form is submitted, user agents may not treat it as a successful control.

When a user submits a form (e.g., by activating a submit button), the user agent identifies the successful controls, builds a form data set (a set of control-name/current-value pairs constructed from successful controls), encodes the form data set according to the content type specified by the enctype attribute of the FORM element, and sends the encoded form data set to the processing agent designated by an action attribute using the protocol specified by the method attribute.

To enhance the use of forms on the Web, the W3C has also recently sponsored the development of XForms. Instead of further altering the existing forms language that is part of HTML, XForms uses a new approach. XForms is based on the widely used extensible markup language (XML) and is written with tags that can be identified by surrounding angle brackets. In general, XForms provides several more elements than other HTML-based forms offer. Additional information about XForms can be found on the XForms institute website.

Also based on XML, extensible HTML (XHTML) is a markup language for Web pages from the W3C that combines HTML and XML into a single format (HTML 4.0 and XML 1.0). Like XML, XHTML can be extended with proprietary tags. Also like XML, XHTML is coded more rigorously than HTML and is less tolerant of variations allowed in HTML coding. XHTML is designed to work in conjunction with XML-based user agents and is touted as the successor of HTML. The W3C has developed a series of specifications for XHTML. The form submission techniques described herein may employ, and are intended to be used with, XForms and/or XHTML.

In addition to controls, labels, and form content, such as text, images files, and the like, forms and other HTML documents, such as confirmation pages, may also including associated metadata. HTML metadata lets authors specify information about a document aside from the document content in a variety of ways. For example, to specify the author of a document, one may use the META element as follows: <META name=“Author” content=“John Smith”>

The above META element specifies a property (here “Author”) and assigns a value to it (here “John Smith”). The META element is not considered content because it would not normally be displayed with the HTML document. The Dublin Core Metadata Initiative (DCMI) provides a set of metadata descriptions about resources on the Internet, such as title, creator, subject, description, date, type, format and the like. DCMI descriptions are intended to be suitable for use by resource discovery tools on the Internet, such as the webcrawlers employed by popular Web search engines and are at the same time sufficiently simple to for use by a wide range of authors and casual publishers who contribute information to the Internet. As a result, DCMI elements have become widely used in documenting Internet resources. The current elements of DCMI are defined in the Dublin Core Metadata Element Set, Version 1.1, and contain definitions for the following properties:

Title: A name given to the resource.

Creator: An entity primarily responsible for making the content of the resource.

Subject: The topic of the content of the resource.

Description: An account of the content of the resource.

Publisher: An entity responsible for making the resource available

Contributor: An entity responsible for making contributions to the content of the resource.

Date: A date associated with an event in the life cycle of the resource.

Type: The nature or genre of the content of the resource.

Format: The physical or digital manifestation of the resource.

Identifier: An unambiguous reference to the resource within a given context.

Source: A reference to a resource from which the present resource is derived.

Language: A language of the intellectual content of the resource.

Relation: A reference to a related resource.

Coverage: The extent or scope of the content of the resource.

Rights: Information about rights held in and over the resource.

In general, metadata is specified by declaring a property and a value for that property either from within a document, using the META element, or from outside a document, by linking to metadata using a LINK element. Each META element specifies a property/value pair. For example, a name attribute identifies a property and a content attribute specifies a property's value, as shown in the example above.

HTML documents from a common source, e.g., part of the same web site, will typically have similar patterns in the metadata associated with each page. For example, the subject, description, author, and/or other metadata elements will be common. A user agent can be configured to detect such a similarity in metadata patterns, as discussed further below.

In addition, the Platform for Internet Content Selection (PICS) is an infrastructure for associating metadata with Internet content. Originally designed to help parents and teachers control what children can access on the Internet, it also facilitates other uses for metadata labels, including code signing, privacy, and intellectual property rights management.

W3C has also introduced the Resource Description Framework (RDF). RDF is a language for representing information about resources in the Web and is particularly intended for representing metadata about Web resources, such as the title, author, and modification date of a Web page, copyright and licensing information about a Web document, or the availability schedule for some shared resource. However, by generalizing the concept of a “Web resource”, RDF can also be used to represent information about things that can be identified on the Web, even when they cannot be directly retrieved on the Web. Examples include information about items available from on-line shopping facilities (e.g., information about specifications, prices, and availability), or the description of a Web user's preferences for information delivery.

RDF is useful for providing information that needs to be processed by applications, rather than being only displayed to users. RDF provides a common framework for expressing this information so it can be exchanged between applications without loss of meaning. RDF uses URI's in an XML-based syntax for describing resources in terms of simple properties and property values. This enables RDF to represent simple statements about resources. For example, consider the group of statements “there is a Person identified by http://www.w3.org/People/EM/contact#me, whose name is John Smith, whose e-mail address is js@w3.org, and whose title is Dr.” the XML-based syntax statements could be represented as:

```
<?xml version=“1.0”?>
<rdf:RDF xmlns:rdf=“http://www.w3.org/1999/02/22-rdf-syntax-ns#”
      xmlns:contact=“http://www.w3.org/2000/10/swap/pim/contact#”>
  <contact:Person
  rdf:about=“http://www.w3.org/People/EM/contact#me”>
    <contact:fullName>John Smith</contact:fullName>
    <contact:mailbox rdf:resource=“mailto:js@w3.org”/>
    <contact:personalTitle>Dr.</contact:personalTitle>
  </contact:Person>
</rdf:RDF>
```

Like HTML, RDF is machine processable and, using URI's, can link pieces of information across the Web. Unlike conventional hypertext, however, RDF URI's can refer to any identifiable thing, including things that may not be directly retrievable on the Web (such as the person John Smith). The result is that in addition to describing such things as web pages, RDF can also describe cars, businesses, people, news events, etc. In addition, RDF properties themselves have URI's, to precisely identify the relationships that exist between the linked items. The form submission techniques described herein may also employ, and are intended to be used with RDF.

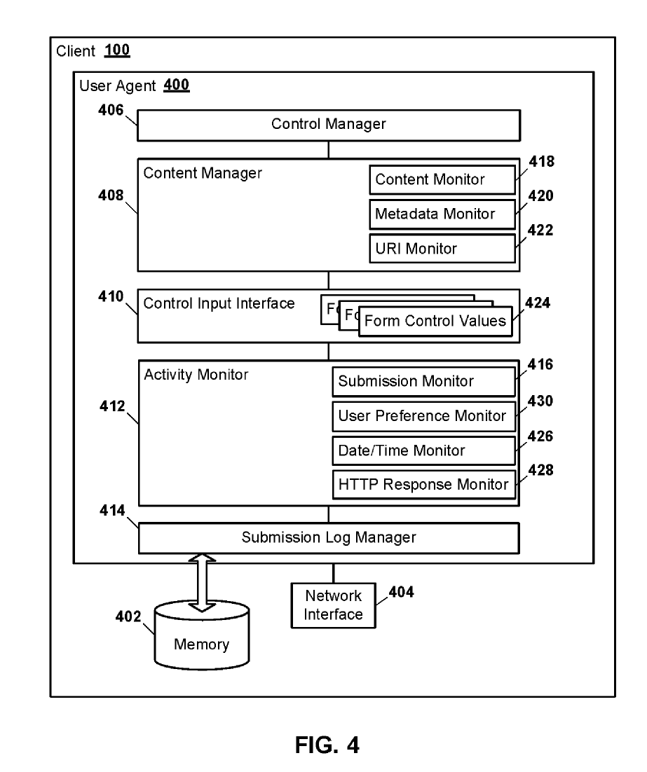

FIG. 4 is a block diagram illustrating a system for preventing double form submissions according to an aspect of the subject matter disclosed herein. In FIG. 4, client 100 includes a user agent 400, a memory 402 associated with the user agent, and a network interface 404 for communicating with remote endpoints via network 102. Accordingly, a system for preventing double form submissions includes means for interfacing user agent 400 to a communication network for receiving a form from a remote endpoint in the communication network. For example, the network interface 404 may be a transmission control protocol/Internet protocol (TCP/IP) interface to an IP network, a wireless communication link to a wireless communication network, an Ethernet connection, or any other communication interface.

Memory 402 may be one or more storage devices associated with user agent 400, such as a random access memory, a disk drive, optical storage device, removable storage device, and the like, and may be connected locally to user agent 400 in the same processor-based system or maybe accessible to user agent 400 over a local area network, wide area network, and the like.

User agent 400 may include one or more of the components illustrated in FIG. 4, depending on the functionality employed, as described herein. In FIG. 4, user agent 400 includes a control manager 406, a content manager 408, a control input interface 410, an activity monitor 412, and a submission log manager 414.

According to one aspect, user agent 400 includes means for detecting initiation of a form submission. As used herein, initiation of a form submission refers to an initial action taken by or at user agent 400 for submitting a form. For example, activity monitor 412 includes a submission monitor 416 that monitors when a form submission is initiated, such as when a submit button on a form is pressed. Submission monitor 416 may also detect any of the actions carried out by user agent 400 to submit a form, including activating a submit button, identifying successful controls, building a form data set, encoding the form data set, and submitting the encoded form data set.

User agent 400 also includes means for determining whether a matching previous form submission exists independent of any scripts received with the form. For example, control manager 406 determines whether a matching previous form submission exists independent of any scripts received with the form. Control manager 406 is operatively coupled to other components in user agent 400 for carrying out this and other functions described herein.

According to one aspect, control manager 406 is configured to determine whether a matching previous form submission exists by comparing identifying information associated with the submission initiation to identifying information associated with previous form submissions. For example, control manager 406 communicates with content manager 408. Content manager 408 includes a content monitor 418 for recognizing and parsing text, controls, and other content on a form, a metadata monitor 420 for recognizing and parsing metadata associated with a form, and a URI monitor 422 for recognizing and parsing URI's associated with a form. URI's associated with the form may include a remote endpoint URI, such as a server URI and/or a processing agent URI, and/or URI's associated with links on the form. In each case, the respective monitor provides the parsed data to control manager 406, which looks for similar patterns in the data to determine whether a matching previous form submission exists.

More particularly, a matching previous form submission may be determined to exist based on similar patterns in the content associated with the previous form submission and the current form submission being initiated. For example, form content may include the same company name or logo, or other identifying text, images, or other content having similarities. Certain types of forms can be recognized by content, such as retail orders, user agreements, privacy agreements, license agreements, account signup and management, banking transactions, email submission via web page, blog submission, forum submissions, chat submissions, and the like.

Metadata monitor 420 can detect similar patterns in metadata associated with each page. For example, the subject, description, author, and/or other metadata elements may be common. HTML, DCMI, and RDF formatted metadata may be monitored, for example. The DCMI metadata set format, when used, may increase the accuracy of metadata monitor 420 in finding similar metadata from one page to the next due to the uniformity in data and approach used by the DCMI metadata set.

URI monitor 422 can detect similar or identical patterns in the URI's associated with each form. Repeating the example given above, two forms from the same website having a URI “http://www.w3.org” may have URI's “http://www.w3.org/TR” and “http://www.w3.org/ST”, which share the pattern “http://www.w3.org”. Of course the URI's may also be identical. Additionally, URI monitor 422 can detect hyperlinks with URI's on forms that point to other pages.

Control manager 406 also communicates with control input interface 410. Control input interface 410 monitors form control values. For example, control input interface 410 may access form controls on a form to associate form control values 424 with one or more of the form controls and to determine the form control values 424 when a form submission is initiated. Control input interface 410 may associate user-entered data, such as text from the keyboard, a selection or drag-and-drop item from a mouse or other pointing device, or a file or other object with a form control values 424. In addition, control input interface 406 may associate previously stored auto-fill data with a form control. User agent 400 may include auto-fill functionality, either directly or through an interrelated add-on feature, such as a plug-in. In general, data is previously saved, either through previously filled-out forms or other means. The data is associated with HTML tag data when saved. For example, user agent 400 may detect an HTML form tag with a name attribute of “First name”. If form data is previously saved and associated with this tag, the first name is automatically filled in with this saved data.

Control manager 406 also communicates with activity monitor 412 to monitor a date of submission and/or a time of submission of forms. Activity monitor 412 includes a date/time monitor 426 for monitoring a date of submission and/or a time of submission of forms and for providing such information to control manager 406 and other components.

Accordingly, as used herein, identifying information for a form submission includes one or more of a URI pattern, form content, form control values, form metadata, a date of submission, a time of submission, and other like form-submission-related information.

According to one aspect of the subject matter disclosed herein, submission log manager 414 controls the storing and retrieving of the identifying information in memory 402. When a form is submitted, submission log manager 414 records identifying information for the form submission in memory 402. Submission log manager 414 may also perform comparisons of identifying information for previously stored form submissions and newly initiated form submissions either directly or in conjunction with control manager 406. For example, control manager 406 may control the submission log manager to check a submission log in the memory that includes identifying information associated with at least one previous form submission when a new form submission is initiated. Submission log manager 414 and/or control manager 406 may then compare the identifying information associated with the submission initiation to identifying information associated with previous form submissions by comparing at least one of a URI pattern, form content, form control values, form metadata, a date of submission, and a time of submission.

According to another aspect of the subject matter disclosed herein, activity monitor 412 includes an HTTP response monitor 428 that monitors HTTP requests and responses. For example, when an HTML form is submitted, an HTTP request is sent to the processing agent using, for example, the HTTP GET method or the HTTP POST method. An HTTP response is then received from the processing agent such as a 200 OK message. Both the request and the response may include a message body containing data exchanged between the user agent and processing agent.

Control manager 406 may determine whether a matching previous form submission exists by determining whether a previous HTTP request exists that has not been responded to. HTTP response monitor 428 monitors HTTP requests and corresponding responses to determine when a previous HTTP request exists that has not been responded to. Control manager 406 uses this information to determine whether a matching previous form submission exists. For example, control manager 406 checks with HTTP response monitor 428 to determine whether a previous HTTP request exists that has not been responded to. In response to determining that a previous HTTP request exists that has not been responded to, control manager 406 determines that a previous HTTP request is unanswered and therefore a matching previous form submission likely exists. Accordingly, newly initiated form submissions may be controlled (as described further below) in light of this likelihood.

Alternatively, or in addition, HTTP response monitor 428 may also compare an HTTP request associated with the newly initiated form submission to HTTP responses corresponding to previous form submissions to determine whether any matching previous form submission exists.

In another aspect, control manager 406, in conjunction with HTTP response monitor 428, may determine whether a currently active form at the user agent corresponds to an un-responded-to previous HTTP request. For example, when a browser window is open and contains a form, control manager 406 can compare one or more of a URI pattern, form content, form control values, form metadata, a date of submission, and a time of submission of the currently active form and the previous HTTP request to determine whether a matching previous form submission exists.

Accordingly, any of the above methods may be used to determine whether a matching previous form submission exists. User agent 400 also includes means for controlling submission of the received form based on the determination of whether a matching previous form submission exists. For example, control manager 406 controls submission of the received form based on the determination of whether a matching previous form submission exists. In response to determining that a matching previous form submission exists, user input may be requested from a user of the user agent regarding completing submission of the received form. Submission of the received form is completed based on the user input received in response to the requested user input.

In one implementation, control manager 406 is configured to request user input from a user by controlling a display to present a dialog box to the user. Activity monitor 412 includes a user preference monitor 430 that determines a user preference regarding forms submission. More particularly, user preference monitor 430 provides selective control to a user regarding completing an initiated form submission. For example, a user may, through a menu command, dialog box, or other user interface associated with user agent 400, indicate a preference regarding whether or not a form submissions that is initiated should be completed, e.g., sent to the processing agent. For example, when control manager 406 determines that a matching previous form submission exists, a question such as: “This form was previously submitted. Are you sure you want to submit this form again?” may be presented to the user with a “yes” or “no” user preference selection. When user preference monitor 430 determines that a user preference regarding completing the form submission is “no”, the form is not submitted. When, however, user preference monitor 430 determines that a user preference regarding completing the form submission is “yes”, the form is submitted.

In another aspect, user preference monitor 430 provides selective control to a user to determine additional preferences through a menu command, dialog box, or other user interface associated with user agent 400. For example, user preferences that instruct user agent 400 how to treat double submission of forms associated with a particular web site or URL may be indicated. Examples of such preferences include “Always for this site” and “Never for this site”. Similarly preferences that instruct user agent 400 how to treat double submission of specific forms (e.g., associated with a particular URL) may be indicated. Examples of such preferences include “Always for this form” and “Never for this form”. As will be appreciated by one of ordinary skill in this art, many other such preferences may be indicated.

According to another aspect, control manager 406 is configured to control submission of the received form by determining a time of submission of a previous form submission and preventing submission of the received form when the time of submission of the previous form submission is within a predetermined time period of the submission initiation of the received form. For example, if a previous form submission occurred more than 15 minutes ago, it may be ignored and the newly initiated form submission may be allowed to proceed automatically. The predetermined time period may be user-configurable. For example, the predetermined time period may be set by a user via user preference monitor 430.

According to another aspect, form submission may be prevented based on user-configurable rules. For example, a user may previously input user preferences to create a rule-set including rules that are applied to form submissions. The rules may take into account specific content or a tag on the received form, a time of submission initiation of the form, a time of submission of one or more previous forms, a URL or web site associated with the form, and many other like characteristics associated with a form submission.

According to another aspect, control manager 406 is configured to control submission of the received form by disabling the submit button of the received form responsive to determining that a matching previous form submission exists. Other controls on the form may also be disabled.

As will be appreciated by one skilled in this art, the various components and subcomponents of FIG. 4 are shown for illustrative purposes only. One or more of the components and/or subcomponents may be combined with other components and/or subcomponents or may simply be omitted while still accomplishing some or all of the functionality described herein. Moreover, additional components may be added to accomplish some or all of the functionality described herein.

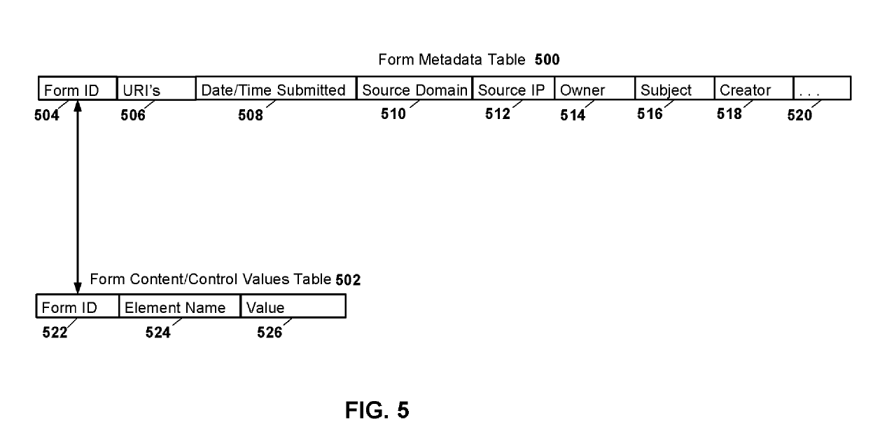

FIG. 5 is a schematic diagram illustrating an exemplary log that may be used for submitted form identifying information according to another aspect of the subject matter described herein. The log may be stored, for example, in memory 402. In FIG. 5, two interrelated tables are shown with their associated fields, namely a form metadata table 500 and a form content/control values table 502.

Form metadata table 500 includes a form identification field 504, a URI field 506, a date/time submitted field 508 (e.g., as determined by date/time monitor 426), a source domain field 510, a source IP field 512, an owner field 514, a subject field 516, a creator field 518, and may include additional fields 520 corresponding to other metadata associated with a web page.

Form content/control values table 502 includes form identification field 522, linked to form identification field 504 in form metadata table 500, an element name field 524, and a value field 526. Form content/control values table 502 is used to store the current values associated with controls on a form as well as other form content. A form identification value may be assigned by submission log manager 414. For control values, each control is listed by control name in element name field 524 along with the current value in value field 526. As discussed above, the current value may be entered by a user or assigned using auto-fill data by user agent 400. For other form content, each element is listed by element name in element name field 524 along with the associated value in value field 526.

It should be understood that FIG. 5 illustrates one possible implementation of a submission log. As will be appreciated by one of ordinary skill in this art, there are many ways to organize form submission data, or data/files in general, for storage and retrieval.

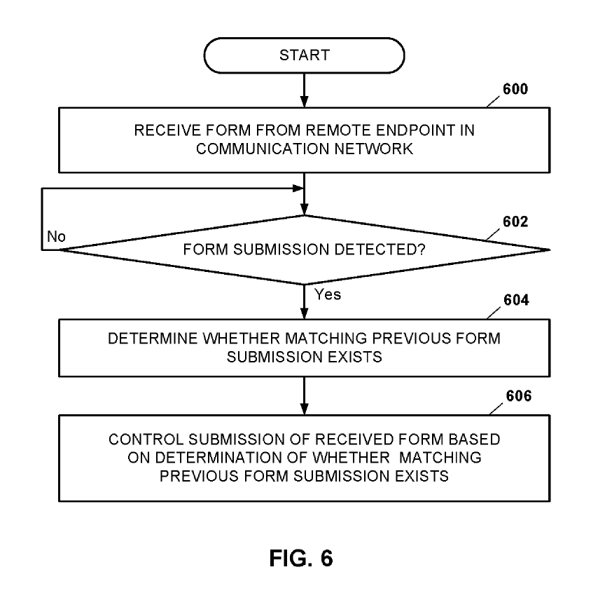

FIG. 6 is a flow diagram illustrating a method for preventing double form submissions at a user agent in a communication network according to an aspect of the subject matter disclosed herein. In block 600, a form is received from a remote endpoint in the communication network. User input is monitored to detect submission initiation for the received form in block 602. In response to detecting submission initiation for the received form in block 602, control manager 406 determines whether a matching previous form submission exists in block 604. For example, control manager 406 may control submission log manager 414 to check a submission log in memory 402. Alternatively, control manager 406 may check with HTTP response monitor 428 in activity monitor 412 to determine if an HTTP response is outstanding, as described above. In either case, the determination of whether a matching previous form submission exists is performed by the user agent independent of any scripts received with the form. In block 606, control manager 406 controls submission of the received form based on the determination of whether a matching previous form submission exists in block 604.

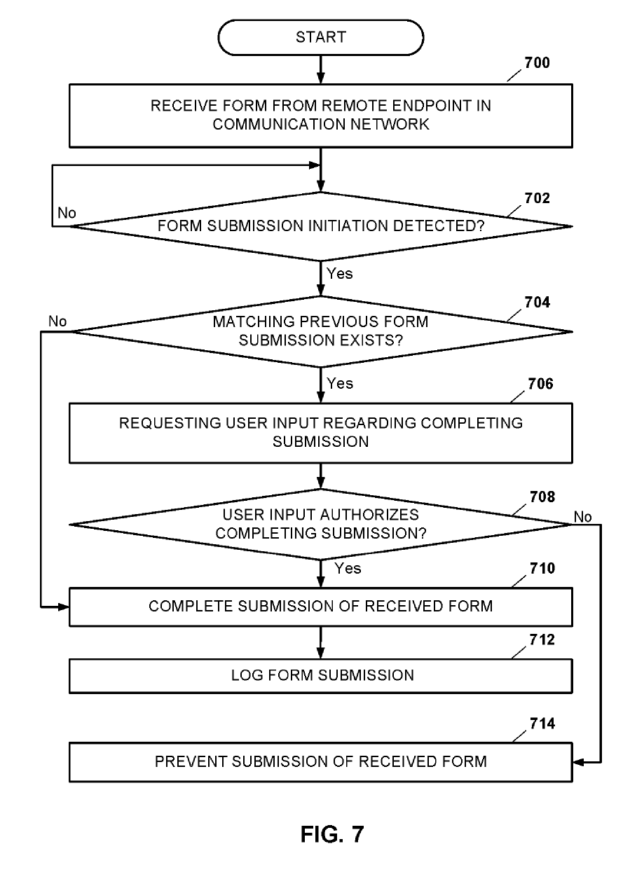

FIG. 7 is a flow diagram illustrating a method for preventing double form submissions at a user agent in a communication network according to another aspect of the subject matter disclosed herein. In block 700, a form is received from a remote endpoint in the communication network. User input is monitored to detect submission initiation for the received form in block 702. In response to detecting submission initiation for the received form in block 702, control manager 406 determines whether a matching previous form submission exists in block 704 via submission log manager 414 and/or HTTP response monitor 428 as described above. In response to determining that a matching previous form submission exists in block 704, user preference monitor 430 requests user input from a user of the user agent regarding completing submission of the received form in block 706. In block 708, user preference monitor 430 determines whether the user input authorizes completing submission of the received form. In response to receiving user input that authorizes completing submission of the received form in block 708, submission of the received form is completed in block 710. Submission of the received form is also completed in block 710 in response to determining that a matching previous form submission does not exist in block 704. In either case, the form submission is added to the submission log in memory 402 by submission log manager 414 in block 712. In response to receiving user input that does not authorize completing submission of the received form in block 708, submission of the received form is prevented in block 714.

It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for preventing double form submission, the method comprising:
at a user agent in a communication network:
receiving a form from a remote endpoint in the communication network;
monitoring user input to detect submission initiation for the received form;
responsive to detecting submission initiation for the received form, determining whether a matching previous form submission exists, wherein the determination of whether a matching previous form submission exists is performed by the user agent independent of any scripts received with the form; and
controlling submission of the received form based on the determination of whether a matching previous form submission exists.

2. The method of claim 1 wherein determining whether a matching previous form submission exists includes comparing identifying information associated with the submission initiation to identifying information associated with previous form submissions.

3. The method of claim 2 wherein comparing identifying information associated with the submission initiation to identifying information associated with previous form submissions includes checking a log that includes identifying information associated with at least one previous form submission.

4. The method of claim 2 wherein comparing identifying information associated with the submission initiation to identifying information associated with previous form submissions includes comparing at least one of a uniform resource indicator (URI) pattern, form content, a form control value, form metadata, a date of submission, and a time of submission.

5. The method of claim 1 wherein determining whether a matching previous form submission exists comprises:
determining whether a previous hypertext transport protocol (HTTP) request exists that has not been responded to; and
determining that a matching previous form submission exists based on the determination that a previous HTTP request exists that has not been responded to.

6. The method of claim 1 wherein determining whether a matching previous form submission exists comprises:
determining whether a previous HTTP request exists that has not been responded to;
responsive to determining that a previous HTTP request exists that has not been responded to, determining whether a currently active form at the user agent corresponds to the un-responded-to previous HTTP request; and
determining that a matching previous form submission exists based on the determination that a currently active form at the user agent corresponds to the un-responded-to previous HTTP request.

7. The method of claim 6 wherein determining whether a currently active form at the user agent corresponds to the un-responded-to previous HTTP request includes comparing at least one of a uniform resource indicator (URI) pattern, form content, a form control value, form metadata, a date of submission, and a time of submission of the currently active form and the previous HTTP request.

8. The method of claim 1 wherein controlling submission of the received form based on the determination of whether a matching previous form submission exists comprises:
responsive to determining that a matching previous form submission exists, requesting user input from a user of the user agent regarding completing submission of the received form; and
completing submission of the received form based on user input received in response to the user input request.

9. The method of claim 8 wherein requesting user input from a user of the user agent includes controlling a display to present a dialog box to the user.

10. The method of claim 1 wherein controlling submission of the received form based on the determination of whether a matching previous form submission exists comprises:
determining a time of submission of a previous form submission; and
allowing submission of the received form when the time of submission of the previous form submission is more than a predetermined time period before the submission initiation of the received form.

11. The method of claim 10 wherein the predetermined time period is user-configurable.

12. The method of claim 1 wherein controlling submission of the received form is based on user-configurable rules, the rules being configured via the user agent.

13. The method of claim 1 wherein controlling submission of the received form based on the determination of whether a matching previous form submission exists includes, responsive to determining that a matching previous form submission exists, disabling at least a submit button of the received form.

14. A computer program product comprising computer executable instructions embodied in a computer-readable medium for performing steps comprising:
receiving a form from a remote endpoint in the communication network;
monitoring user input to detect submission initiation for the received form;
responsive to detecting submission initiation for the received form, determining whether a matching previous form submission exists, wherein the determination of whether a matching previous form submission exists is performed by the user agent independent of any scripts received with the form; and
controlling submission of the received form based on the determination of whether a matching previous form submission exists.

15. At a user agent in a communication system, a system for preventing double form submissions, the system comprising:
means for interfacing a user agent to a communication network for receiving a form from a remote endpoint in the communication network and for submitting forms;
means for detecting initiation of a form submission;
means for determining whether a matching previous form submission exists independent of any scripts received with the form; and
means for controlling submission of the received form based on the determination of whether a matching previous form submission exists.

16. At a user agent in a communication system, a system for preventing double form submissions, the system comprising:
a network interface that interfaces a user agent to a communication network for receiving a form from a remote endpoint in the communication network and for submitting forms;
an activity monitor that detects initiation of a form submission; and
a control manager that determines whether a matching previous form submission exists independent of any scripts received with the form and controls submission of the received form based on the determination of whether a matching previous form submission exists.

17. The system of claim 16 wherein the control manager is configured to determine whether a matching previous form submission exists by comparing identifying information associated with the submission initiation to identifying information associated with previous form submissions.

18. The system of claim 17 comprising a submission log manager and a memory, wherein the control manager is configured to control the submission log manager to check a log in the memory that includes identifying information associated with at least one previous form submission.

19. The system of claim 17 comprising:
a content manager that monitors form content, form metadata, and URI's,
a control input interface that monitors form control values,
wherein the activity monitor monitors at least one of a date of submission and a time of submission; and
wherein the control manager is configured to compare identifying information associated with the submission initiation to identifying information associated with previous form submissions by comparing at least one of a URI pattern, form content, a form control value, form metadata, a date of submission, and a time of submission.

20. The system of claim 16 wherein the activity monitor monitors HTTP requests and responses and the control manager determines whether a matching previous form submission exists by:
determining whether a previous HTTP request exists that has not been responded to; and
determining that a matching previous form submission exists based on the determination that a previous HTTP request exists that has not been responded to.

21. The system of claim 16 wherein the activity monitor monitors HTTP requests and responses and the control manager determines whether a matching previous form submission exists by:
determining whether a previous HTTP request exists that has not been responded to;
responsive to determining that a previous HTTP request exists that has not been responded to, determining whether a currently active form at the user agent corresponds to the un-responded-to previous HTTP request; and
determining that a matching previous form submission exists based on the determination that a currently active form at the user agent corresponds to the un-responded-to previous HTTP request.

22. The system of claim 21 wherein the control manager is configured to determine whether a currently active form at the user agent corresponds to the un-responded-to previous HTTP request by comparing at least one of a URI pattern, form content, a form control value, form metadata, a date of submission, and a time of submission of the currently active form and the previous HTTP request.

23. The system of claim 16 wherein the control manager is configured to control submission of the received form based on the determination of whether a matching previous form submission exists by:
responsive to determining that a matching previous form submission exists, requesting user input from a user of the user agent regarding completing submission of the received form; and
completing submission of the received form based on user input received in response to the requested user input.

24. The system of claim 22 wherein the control manager is configured to request user input from a user of the user agent by controlling a display to present a dialog box to the user.

25. The system of claim 16 wherein the control manager is configured to control submission of the received form based on the determination of whether a matching previous form submission exists by:
determining a time of submission of a previous form submission; and
allowing submission of the received form when the time of submission of the previous form submission is more than a predetermined time period before the submission initiation of the received form.

26. The system of claim 25 wherein the predetermined time period is user-configurable.

27. The system of claim 16 wherein the control manager is configured to control submission based on user-configurable rules, the rules being configured via the user agent.

28. The system of claim 16 wherein the control manager is configured to control submission of the received form based on the determination of whether a matching previous form submission exists by disabling at least a submit button of the received form responsive to determining that a matching previous form submission exists.
